(19) United States
(12) Patent Application Publication
(10) Pub. No.: US 2023/0166955 A1
(43) Pub. Date: Jun. 1, 2023

(54) ROTATABLE CAP OPENER

(71) Applicant: ARON PRYS, JERUSALEM (IL)

(72) Inventor: ARON PRYS, JERUSALEM (IL)

(21) Appl. No.: 17/549,960

(22) Filed: Dec. 14, 2021

(30) Foreign Application Priority Data
Dec. 1, 2021 (IL) 288592

(51) Int. Cl. B67B 7/18

(52) U.S. Cl. CPC B67B 7/186

(57) ABSTRACT

An opener for a rotatable cap, the opener including a rounded plate being fixed to a first arm; a strap, a second arm, first end thereof being pivotally connected to the rounded plate, and second end of the second arm being fixed to an end of the strap, thereby rotation of the rounded plate by the first arm fixed thereto while the strap surrounds the rotatable cap, slides a first portion of the strap to attach the strap to the rotatable cap, and rotates the strap, while being attached to the rotatable cap, to rotate the rotatable cap.

### CROSS-REFERENCE TO RELATED APPLICATIONS

This application claims the benefit of priority from Israel Patent Application No. 288592, filed Dec. 1, 2021, the disclosure of which is incorporated herein by reference.

### TECHNICAL FIELD

The invention relates to the field of cap openers of bottles, jars and other cylindrical objects.

### BACKGROUND

A plier may open and close a bottle.

However, a plier for a smaller perimeter cap of a bottle, is not suitable for a larger perimeter cap of a jar and vice versa.

There is a long felt need to provide a solution to the above-mentioned and other problems of the prior art.

### SUMMARY

A cap opener including:
a rounded plate fixed to a first arm;
a strap; and
a second arm.

### BRIEF DESCRIPTION OF THE DRAWINGS

Embodiments, features, and aspects of the invention are described herein in conjunction with the following drawings, in which:

FIG. 1 depicts a cap opener according to one embodiment of the invention;

FIG. 2 depicts the cap opener of FIG. 1 prepared for opening a cap;

FIG. 3 depicts the cap opener of FIG. 1, while the strap attaches cap 24; and

FIG. 4 is a top view of a portion of the strap being attached to a portion of the rounded plate.

The drawings are not necessarily drawn to scale.

### DETAILED DESCRIPTION

The invention will be understood from the following detailed description of embodiments of the invention, which are meant to be descriptive and not limiting. For the sake of brevity, some well-known features are not described in detail.

The reference numbers have been used to point out elements in the embodiments described and illustrated herein, in order to facilitate the understanding of the invention. They are meant to be merely illustrative, and not limiting. Also, the foregoing embodiments of the invention have been described and illustrated in conjunction with systems and methods thereof, which are meant to be merely illustrative, and not limiting.

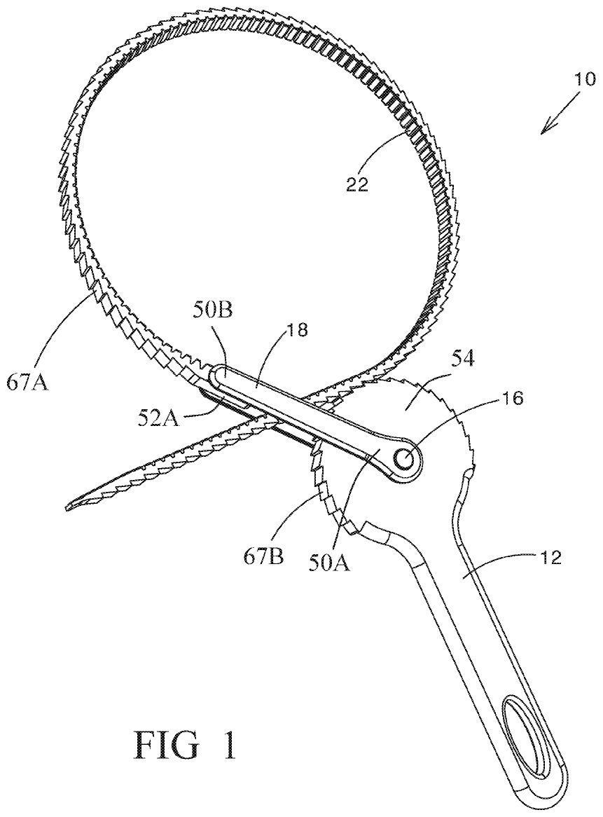

FIG. 1 depicts a cap opener according to one embodiment of the invention.

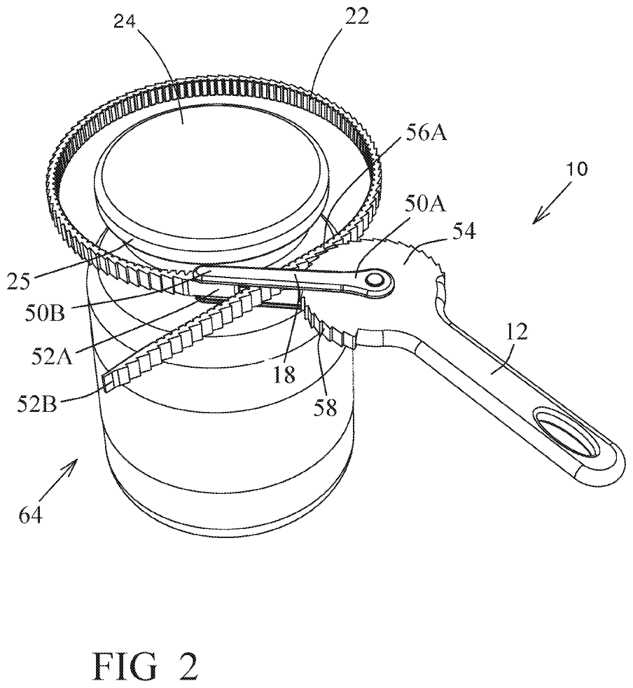

FIG. 2 depicts the cap opener of FIG. 1 prepared for opening a cap.

Referring to FIG. 2, a cap opener 10 includes a rounded plate 54 fixed to an arm 12; an arm 18, whose first end 50A is pivotally (16) connected to rounded plate 54, and whose second end 50B is fixed to a first end 52A of a strap 22.

The first end 52A of strap 22 is configured for attaching a cap 24. Strap 22 is configured for surrounding a cap 24, thus a portion 56A of strap 22 attaches the thickness 58 of rounded plate 54.

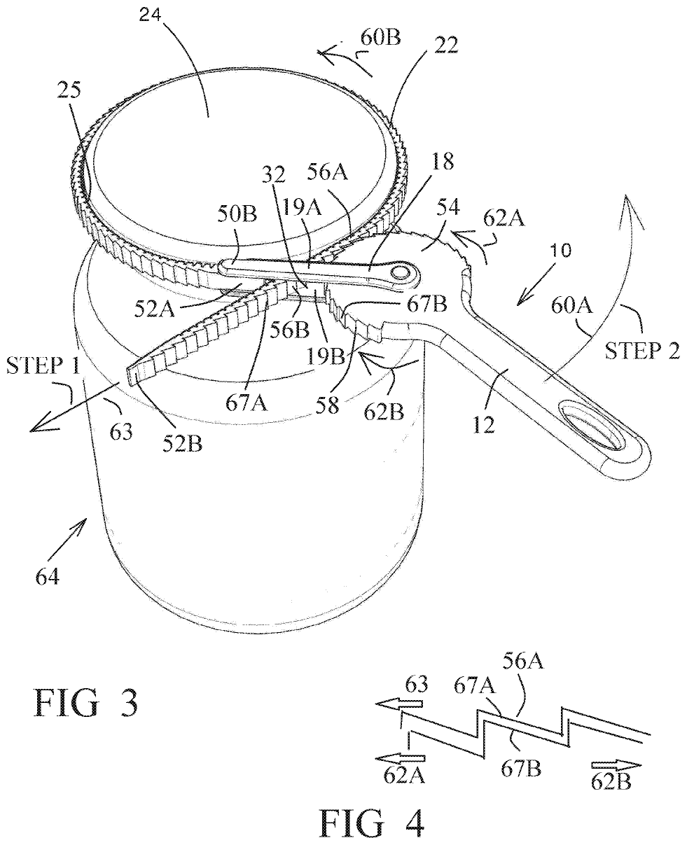

FIG. 3 depicts the cap opener of FIG. 1, while the strap attaches cap 24.

At the first step, the user pulls second end 52B of strap 22, for attaching the entire of the circumference of cap 24 to strap 22. This pulling of second end 52B pulls first end 52A of strap 22 and as well pulls second end 50B of arm 18 fixed thereto, thus draws thickness 58 of rounded plate 54 towards circumference 25 of cap 24 thus to attach portion 56A of strap 22, thus to produce friction therebetween.

At the second step, the user rotates (60A) handle 12 to rotate (62A) thickness 58 of rounded plate 54.

Rotation 62A of thickness 58 of rounded plate 54 together with the friction between thickness 58 of rounded plate 54 and strap 22, slide (63) portion 56A of strap 22 to increase the attachment of strap 22 on thickness 58 of rounded plate 54, thus to increase attachment of strap 22 on circumference 25 of cap 24.

Rotation 60A of handle 12, further applies rotation force 60B on strap 22.

The increase of the attachment of strap 22 on circumference 25 of cap 24 together with rotation 60B of strap 22 rotates rounded plate 54, either to release rounded plate 54 from bottle or jar 64, or to tighten thereto.

The friction between thickness 58 of rounded plate 54 and strap 22 may be strengthened by cogs 67B of thickness 58 of rounded plate 54 interlacing cogs 67A of strap 22 upon pressing one another.

This friction is required only at the rotation of direction 62A.

FIG. 4 is a top view of a portion of the strap being attached to a portion of the rounded plate.

Thus cogs 67A and 67B may be uni-directional, and being complementary one to the other, thereby idling rotation of the direction 62B, being opposite to direction 62A.

Referring again to FIG. 3, arm 18 may include two sub arms 19A and 19B, for forming a gap 32 therebetween, through which a portion 56B of strap 22, being near to portion 56A, is threaded. Gap 32 provides that portion 56A of strap 22 is disposed at the height of circumference 25 of cap 24.

Thus, in one aspect, the invention is directed to an opener (10) for a rotatable cap (24), the opener including:
a rounded plate (54) being fixed to a first arm (12);
a strap (22); and
a second arm (18), first end (50A) thereof being pivotally (16) connected to the rounded plate (54), and second end (50B) of the second arm (18) being fixed to an end (52A) of the strap (22),

thereby rotation (62B) of the rounded plate (54) by the first arm (12) fixed thereto while the strap (22) surrounds the rotatable cap (24), slides (63) a first portion (56A) of the strap (22) to attach the strap (22) to the rotatable cap (24), and rotates (60B) the strap (22), while being attached to the rotatable cap (24), to rotate the rotatable cap (24).

The strap (22) and the thickness (58) of the rounded plate (54) may include cogs (67A,67B) being interlaceable with one another, thereby the interlacing provides the sliding (63) of the first portion (56A) of the strap (22) upon the rotation (62A) of the rounded plate (54).

The interlaceable cogs (67A,67B) may be uni-directional, for strengthening interlacing between the interlaceable cogs (67A,67B), for strengthening the sliding (63) the first portion (56A) of the strap (22) upon the rotation (62A) of the rounded plate (54), while idling upon rotating (62B) the rounded plate (54) opposite to the rounded plate rotation (62A).

The second arm (18) may include two sub arms (19A,19B) forming a gap (32) therebetween, thereby a second portion (56B) of the strap (22) is threadable through the gap (32), for disposing the first portion (56A) of the strap at a height of a circumference (25) of rotatable the cap (24).

In the figures and/or description herein, the following reference numerals (Reference Signs List) have been mentioned:
numeral 10 denotes the cap opener according to one embodiment of the invention;
12: arm being a handle for the user;
16: pivotal connection;
18: arm connecting rounded plate 54 to strap 22;
19A,19B: sub-arms of arm 18;
22: strap;
24: rotatable cap;
25: circumference of cap 24;
32: gap;
50A,50B: ends of arm 18;
52A,52B: ends of strap 22;
56A: portion of strap 22 being pressed by thickness 58 of rounded plate 54;
56B: portion of strap 22 being threaded through arm 18;
58: thickness of rounded plate 54;
60A: rotation of handle/arm 12 for rotating cap 24;
60B: rotation of cap 24 applied by rotation of strap 22 seizing cap 24;
62A: rotation of rounded plate for seizing and for rotating cap 24;
62B: rotation of rounded plate for releasing strap 22 from cap 24;
63: sliding of portion 56A of strap 22, applied by rotation 62A of rounded plate 54; the sliding is accompanied by friction and/or by interlaced cogs;
64: jar or bottle being capped by rounded cap 24;
67A: cogs of strap 22;
67B: cogs of thickness 58 of rounded plate 54;

The foregoing description and illustrations of the embodiments of the invention have been presented for the purpose of illustration, and are not intended to be exhaustive or to limit the invention to the above description in any form.

Any term that has been defined above and used in the claims, should be interpreted according to this definition.

The reference numbers in the claims are not a part of the claims, but rather used for facilitating the reading thereof. These reference numbers should not be interpreted as limiting the claims in any form.

What is claimed is:

1. An opener for a rotatable cap, the opener comprising:
a rounded plate being fixed to a first arm;
a strap; and
a second arm, first end thereof being pivotally connected to said rounded plate, and second end of said second arm being fixed to an end of said strap,
thereby rotation of said rounded plate by said first arm fixed thereto while said strap surrounds said rotatable cap,
slides a first portion of said strap to seize said strap to said rotatable cap, and rotates said strap, while being seized to said rotatable cap, to rotate said rotatable cap.

2. The opener according to claim 1, wherein said strap and a thickness of said rounded plate comprise cogs being interlaceable with one another,
thereby said interlacing provides said sliding said first portion of said strap upon said rotation of said rounded plate.

3. The opener according to claim 2, wherein said interlaceable cogs are uni-directional, for strengthening interlacing between said interlaceable cogs, for strengthening said sliding said first portion of said strap upon said rotation of said rounded plate, while idling upon rotating said rounded plate opposite to said rounded plate rotation.

4. The opener according to claim 1, wherein said second arm comprises two sub arms forming a gap therebetween,
thereby a second portion of said strap is threadable through said gap, for disposing said first portion of said strap at a height of a circumference of rotatable said cap.
